(19) United States
(12) Patent Application Publication
(10) Pub. No.: US 2005/0211010 A1
(43) Pub. Date: Sep. 29, 2005

(54) Motorcycle handle bar

(76) Inventor: Dave Zimmerman, Pecatonica, IL (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6780, US

(21) Appl. No.: 11/030,838

(22) Filed: Jan. 7, 2005

Related U.S. Application Data
(60) Provisional application No. 60/555,517, filed on Mar. 23, 2004.

(51) Int. Cl. B62K 21/12

(52) U.S. Cl. 74/551.1

(57) ABSTRACT

A handlebar assembly that provides the ability to economically produce handlebars is presented. The handlebar is formed from multiple pieces. The pieces include a mounting piece that connects to two handlebar pieces that are bent to form the handlebar shape and mounts to the top tree. The mounting piece is sized to fit a particular style of tree. The pieces are permanently joined by means such as welding, bonding, brazing, etc. The handlebar pieces are rotated to a desired horizontal angle and a desired vertical angle selected by the consumer prior to being joined to the mounting piece. The mounting piece may be solid or be hollowed out with a central support member. The solid mounting piece has an internal channel for passing wire to and through the handlebar pieces.

### CROSS-REFERENCE TO RELATED PATENT APPLICATIONS

This patent application claims the benefit of U.S. Provisional Patent Application No. 60/555,517, filed Mar. 23, 2004.

### FIELD OF THE INVENTION

This invention pertains to motorcycle handlebars, and more particularly, to motorcycle handlebars with the electrical wiring disposed within the handlebars.

### BACKGROUND OF THE INVENTION

Many biker enthusiasts upgrade various components of their motorcycle. One such component is the handlebar. The handgrip areas of a handlebar are almost universally used for mounting controls including electrical switches for operating lights, horns and directional signals. The manual operating controls such as throttles and brakes usually have external cables. However, the electrical switches, which usually are small gauged wires that are relatively fragile, often have their insulated wires protected by running through the interior of the handlebar tube from the handgrip regions and exit the handlebar somewhere near the tree.

Typically, the handlebars are formed from a single tube of tubular steel and bent in a suitable shape to provide the mounting location for the handgrips. The central section of the handlebar is secured to the top tree of the motorcycle with fasteners or via risers. The risers and associated clamps can loosen during operation, which results in the handlebar rotating if it is not properly secured. A better method to produce and install handlebars is needed.

The invention provides such a method to produce and install handlebars. These and other advantages of the invention, as well as additional inventive features, will be apparent from the description of the invention provided herein.

### BRIEF SUMMARY OF THE INVENTION

The invention provides a handlebar assembly that provides the ability to economically produce handlebars. The handlebar is formed from multiple pieces. The pieces include a mounting piece that connects to two handlebar pieces that are bent to form the handlebar shape and mounts to the top tree. The mounting piece is sized to fit a particular style of tree. The pieces are permanently joined by means such as welding, bonding, brazing, etc.

The handlebar pieces are rotated to a desired horizontal angle and a desired vertical angle prior to being joined to the mounting piece. The handlebar pieces may be rotated or otherwise formed to a wide range of angles and configurations based upon the desired position of the rider. The mounting piece may be solid or be hollowed out with support members. The solid mounting piece has an internal channel for passing wire to and through the handlebar pieces.

Other aspects and features, and advantages of the invention will become more apparent from the following detailed description when taken in conjunction with the accompanying drawings.

### BRIEF DESCRIPTION OF THE DRAWINGS

FIG. 1 is an isometric view showing the handlebar of the invention installed on a motorcycle;

FIG. 2 is an isometric view of the pieces of handlebar of FIG. 1;

FIG. 3 is a side view of the handgrip area of the handlebar of FIG. 1;

FIG. 4a is a bottom view of an embodiment of the mounting piece in accordance with the teachings of the invention;

FIG. 4b is a bottom view of an alternate embodiment of the mounting piece;

FIG. 4c is an end view of the mounting piece of FIG. 4a along line 4c;

FIGS. 4d-4h illustrate various tops of the mounting piece and is a cross-sectional view of the mounting piece of FIG. 4a along line 4d-h;

FIG. 5 is an isometric view of the handlebar of the invention installed on a top tree of a motorcycle;

FIG. 6 is an isometric view of the handlebar of FIG. 5 illustrating electrical wires running through the handlebar assembly;

FIGS. 7-8 illustrate various embodiments of the handlebar assembly of the invention;

FIG. 9 illustrates an alternate embodiment of the handlebar in accordance with the invention;

FIG. 10a illustrates an embodiment of the handlebar having a mount for a tachometer and/or other instrumentation; and

FIG. 10b is a cross sectional view of the handlebar of FIG. 10a illustrating the pre-drilled slot section.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The invention provides a method to build handlebars that allows standard parts to be put together to produce numerous styles of handlebars. The method eliminates the need for risers and clamps and streamlines and simplifies the installation process by having a single unit to install. In one embodiment, the handlebars when installed create the illusion that the fork tubes continue through the tree and become the actual handlebar. Turning to the drawings, wherein like reference numerals refer to like elements, the invention is illustrated as being implemented in a suitable motorcycle. Those skilled in the art will appreciate that the invention may be practiced with other motorcycle configurations.

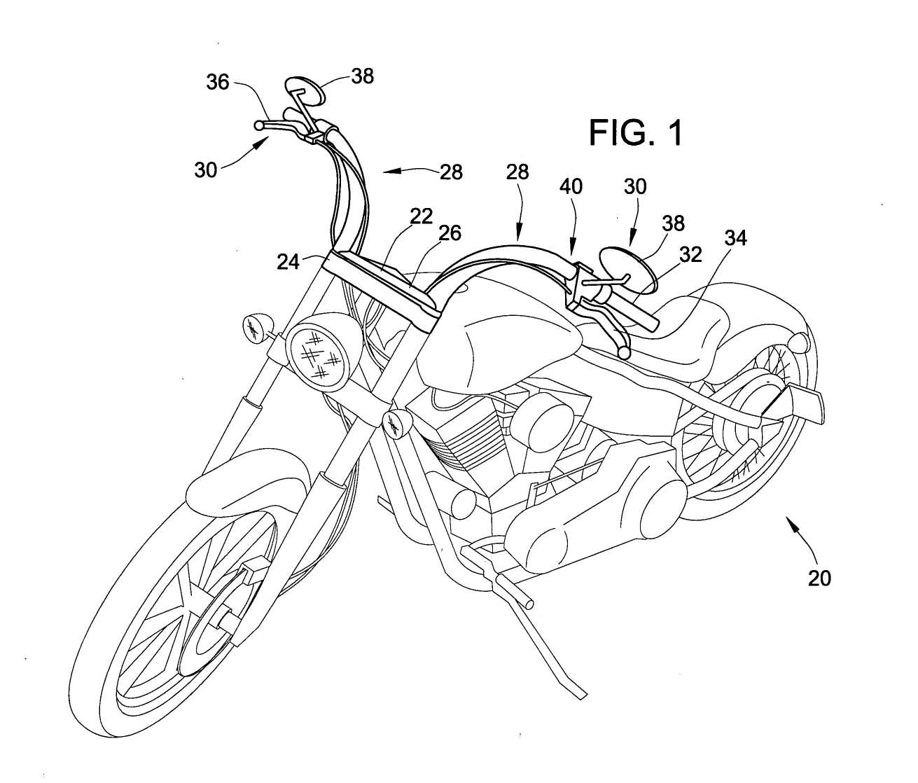

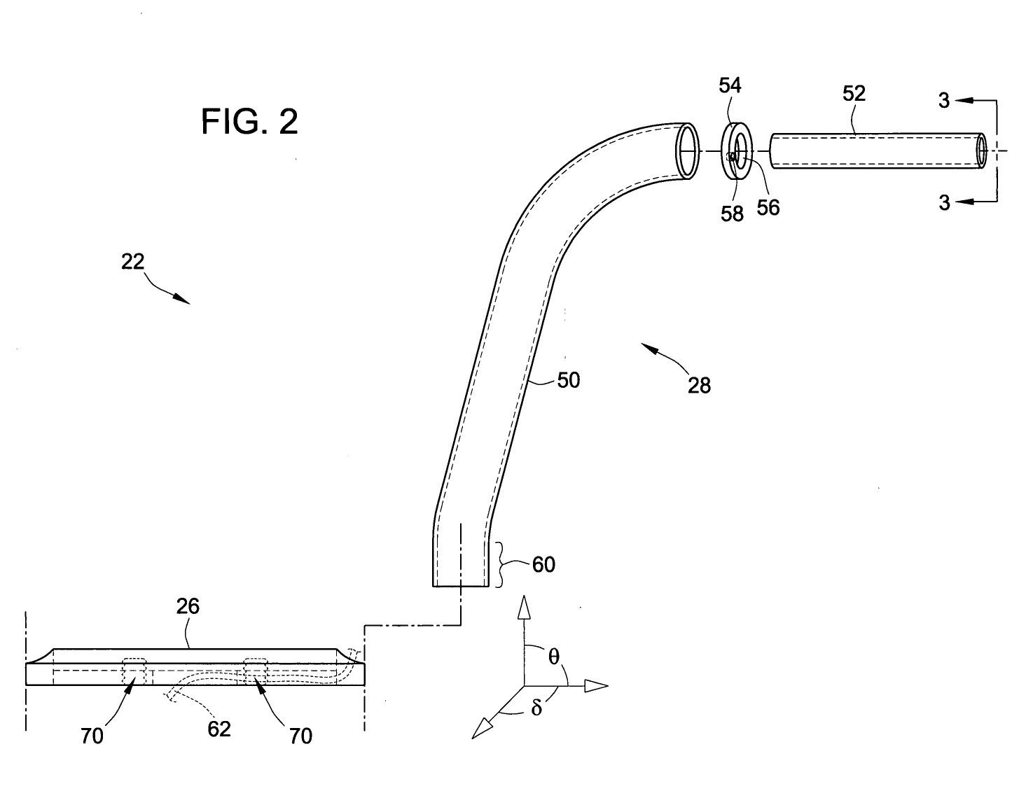

FIG. 1 illustrates an example of a suitable motorcycle 20 on which the invention may be implemented. The handlebar 22 mounts on the tree 24 of the motorcycle 20. In one embodiment, the handlebars create the illusion that the fork tubes continue through the tree and become the actual handlebar. This embodiment is illustrated in FIG. 1. The handlebar 22 has a mounting piece 26 that is mounted to the tree 24 and handlebar sections 28. Equipment and accessories (generally designated by 30), such as grips 32, clutch lever 34, brake lever 36, mirror 38 and switches 40, are attached to the handlebar sections 28 and grip tubes (as shown in FIG. 2).

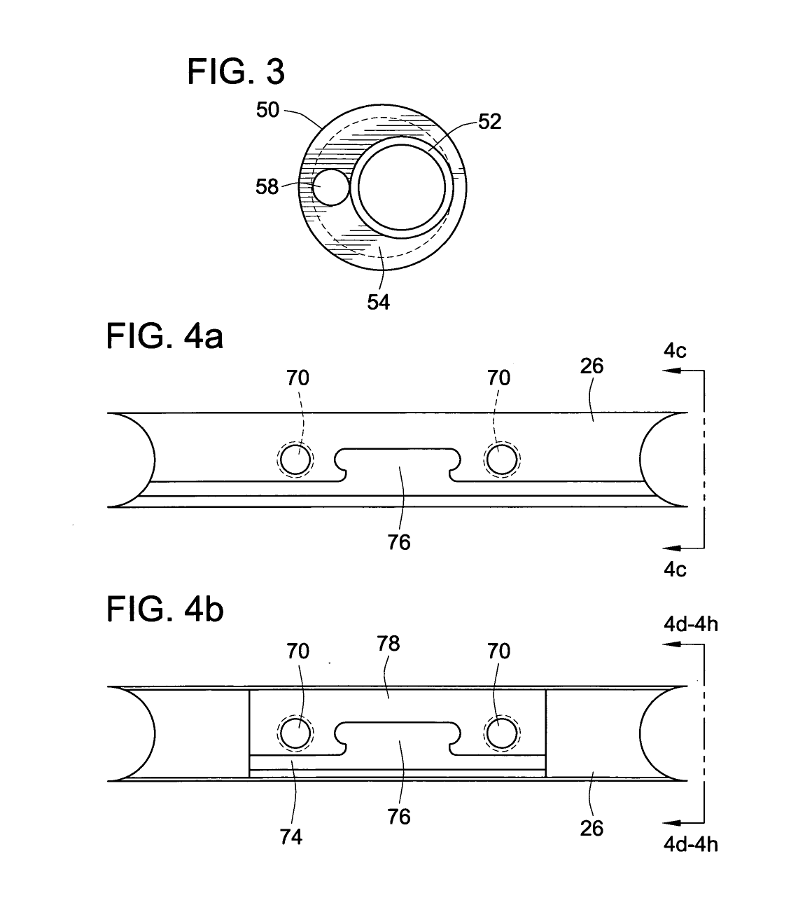

FIG. 2 shows the handle bar sections. The handlebar 22 has a mounting piece 26, handlebar tube 50, grip tube 52, and bushing 54. The grip tube 52 is inserted into opening 56 of bushing 54 and is attached to handlebar tube 50. The tube 52 and bushing 54 may be welded, brazed, bonded, etc. to handlebar tube 50. The material of tubes 50, 52, and bushing 54 is metal, aluminum, or other durable material. The bushing 54 has opening 58 (see FIG. 3) for enabling electrical wire to be run through the tube 50 to connect to electrical components such as a throttle, horn, turn signal, and the like. Note that the size and location of opening 58 will vary, depending on model and manufacturer.

The handlebar section 28, which consists of handlebar tube 50, grip tube 52, and bushing 54, is attached by welding, brazing, bonding, etc. to mounting piece 26 at a desired horizontal and vertical angle. For example, the handlebar section 28 can be such that section 60 is straight up with respect to mounting piece 26 (i.e., angle θ=0 and angle δ=0 where θ is the angle from the vertical axis “z” towards the “xy” plane and δ is the angle from the horizontal axis “x” towards the “yz” plane) or at any other angles.

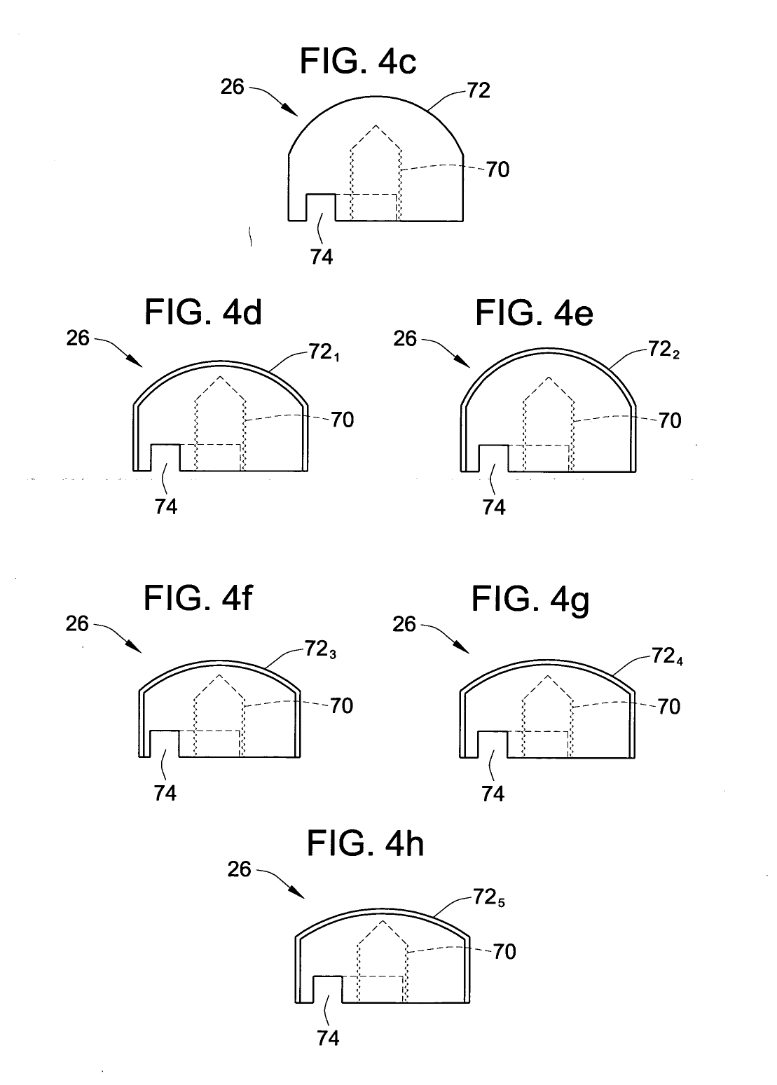

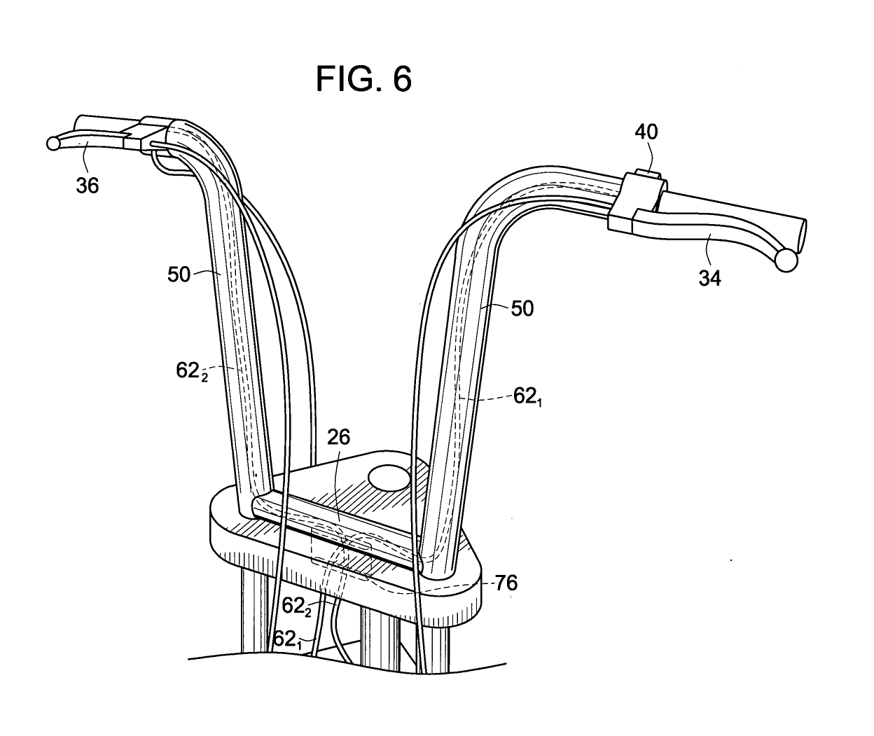

Turning now to FIG. 4a, the mounting piece 26 has threaded holes 70 for mounting the mounting piece 26 to tree 24 from the bottom so that the top 72 of the mounting piece is continuous (see FIG. 4c). The mounting piece 26 is sized based on the tree being used. In one embodiment, the mounting piece is forged, machined, stamped, or extruded barstock and is chrome plated after assembly. A logo may be placed on the mounting piece 26. A channel 74 for routing electrical wire 62 (see FIG. 2) is provided along one side of the mounting piece 26. While FIGS. 4a-h show the channel 74 along one side, those skilled in the art will recognize that the channel may be placed on the opposite side shown. The mounting piece 26 has an opening 76 that fits over the opening on the tree 24 for passing wire (see FIG. 6). The mounting piece may be a solid piece as shown in FIG. 4a or it may have a solid section 78 as shown in FIG. 4b that results in less material being used in mounting piece 26. Solid section 78 may be welded or bonded to mounting piece 26 or it may be part of the mounting piece when the mounting piece is forged, machines, or stamped. The top 72 of the mounting piece 26 may comprise various radii. FIGS. 4d-4h illustrate various radii 72₁ to 72₅. Note that any other desirable profile or contour can be used.

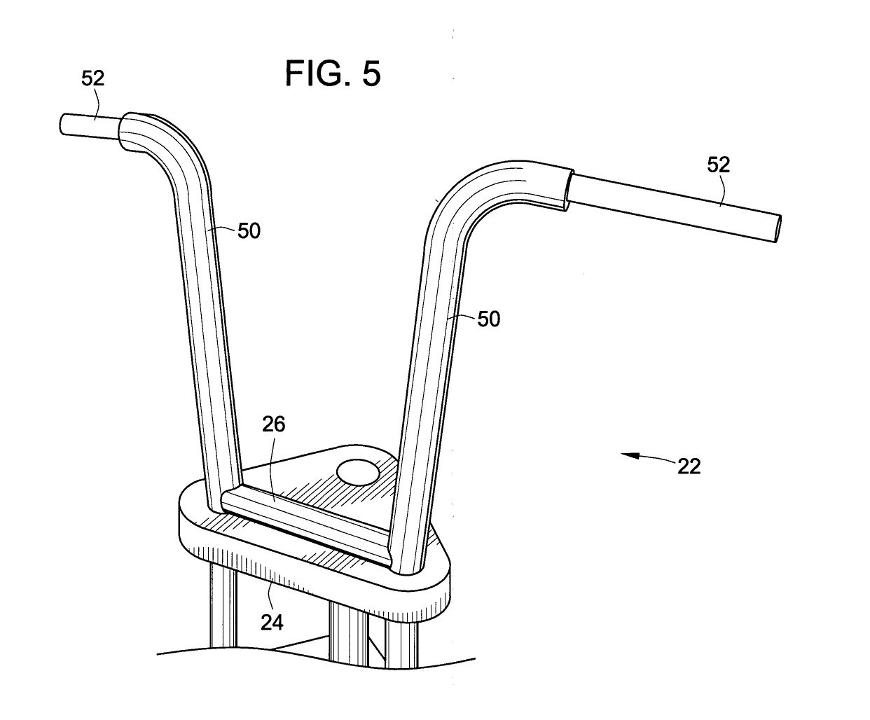

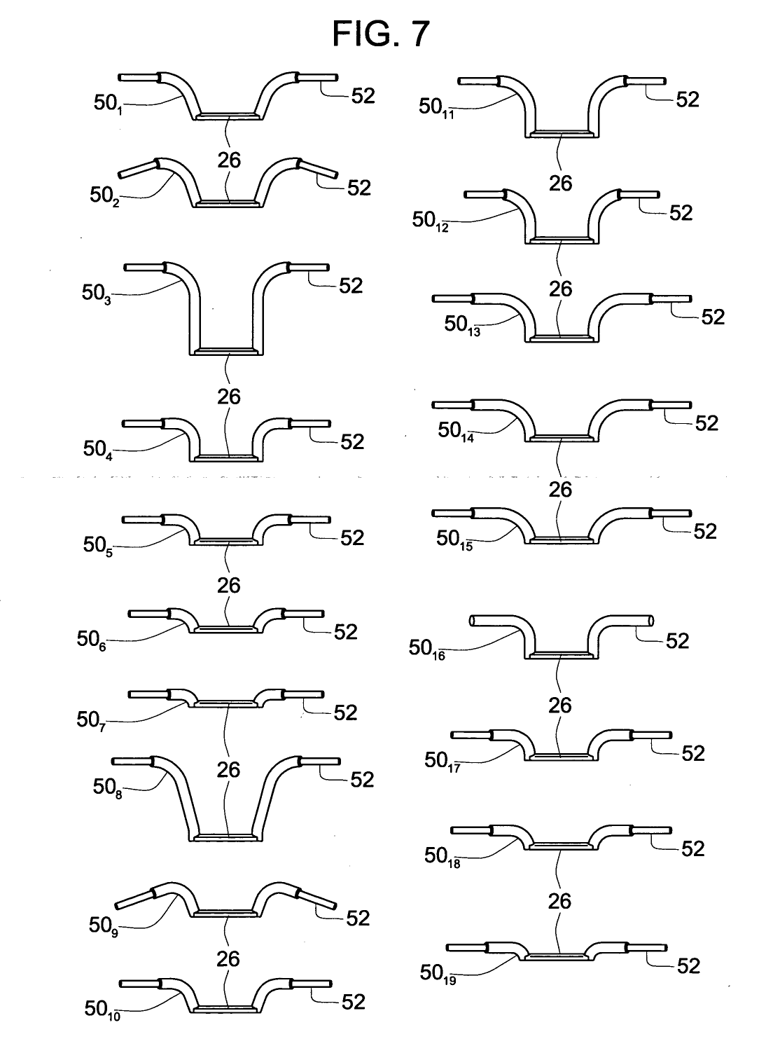

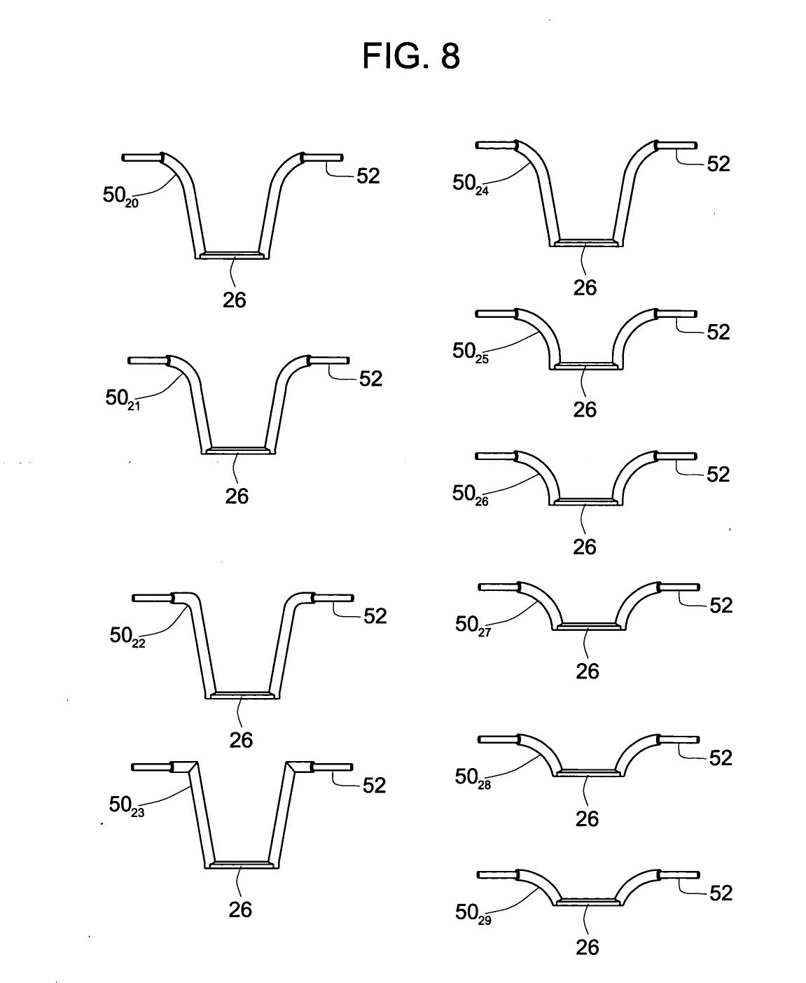

FIG. 5 illustrates the handlebar 22 mounted to a tree 24. The standard stock fork tube plug nut (not shown) on the tree is covered by handlebar section 28. A replacement plug or a modified plug is used if the stock plug interferes with the handlebar installation. FIG. 6 illustrates electrical wires 62₁, 62₂ routed through the opening 76, channel 74 and handlebar tube 50. FIGS. 7 and 8 illustrate various styles of handlebar tubes 50₁ to 50₂₉ attached to mounting piece 26. The mounting piece is selected based on the style of handlebar tubes and the style of bike (e.g., motorcycle type).

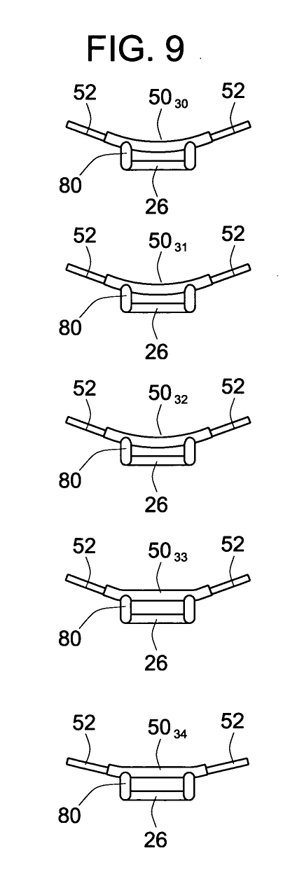

Turning now to FIG. 9, an alternate embodiment of the handlebar of the invention is shown. The handlebar has mounting piece 26, handlebar tube 50, grip tube 52, and riser 80. The riser is welded, brazed, or otherwise attached to mounting piece 26. In this embodiment, only one handlebar tube 50 is required. The handlebar tube 50 is attached to riser 80.

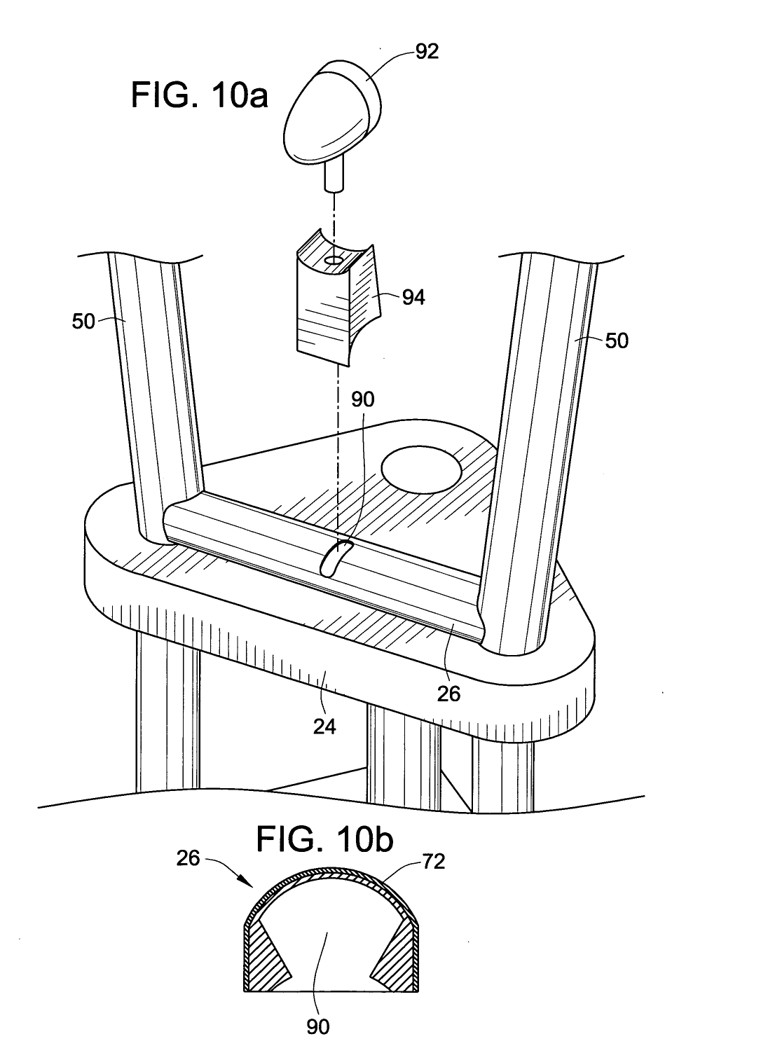

Turning now to FIG. 10a, the mounting piece 26 may also have a slot 90 pre-drilled through a portion of the mounting piece 26 (see FIG. 10b) such that a consumer can finish drilling out the slot to mount instrumentation 92 (e.g., a tachometer) to the mounting piece. A mounting bracket 94 that has a mounting through-hole for the tachometer wiring and tachometer (or multiple through-holes) and a threaded hole (not shown) for mounting the bracket 94 to the mounting piece 26 is used. The instrumentation wiring is fed through the through-hole and tree to the appropriate location in the motorcycle.

The handlebar is manufactured by receiving customer parameters and manufacturing the handlebar to meet the customer parameters. The customer parameters include a desired handlebar style, a desired handlebar horizontal angle, a desired handlebar vertical angle, and a bike type. The desired handlebar style includes the various styles of handlebar tubes illustrated in FIGS. 7 and 8 as well as custom styles. The bike type indicates the type of motorcycle (e.g., Harley Davidson cruiser) from which the tree configuration and size can be determined. The mounting piece is selected from the bike type. The handlebar tubes are selected based on the desired handlebar style and are bent to the desired configuration (e.g., horizontal and vertical angles). The grip tube and bushing is connected to the handlebar tubes. The handlebar tube is mounted to the mounting piece and integrally attached therewith as previously described.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A bike handlebar formed from multiple pieces comprising:
a mounting piece adapted to mount to a bike tree;
a plurality of handlebar tubes integrally attached to the mounting piece, the handlebar tubes oriented at a desired position and bent to form a desired shape;
a bushing mounted within each of the plurality of handlebar tubes, the bushing having a central opening and an offset opening; and
a grip tube attached to each bushing and mounted within the central opening.

2. The bike handlebar of claim 1 wherein the bike handlebar is attached to a motorcycle.

3. The bike handlebar of claim 1 wherein the handlebar tubes are rotated to a desired horizontal angle and a desired vertical angle.

4. The bike handlebar of claim 1 wherein the handlebar tubes are integrally attached to the mounting piece by at least one of welding means, bonding means, or brazing means.

5. The bike handlebar of claim 1 wherein the mounting piece has threaded holes for mounting the mounting piece to the bike tree from the bottom of the bike tree such that the top of the mounting piece is continuous.

6. The bike handlebar of claim 1 wherein the mounting piece has at least one channel for routing electrical wire.

7. The bike handlebar of claim 1 further comprising a riser attached to the mounting piece and wherein the plurality of handlebar tubes comprises a single handlebar tube that is connected to the riser.

8. The bike handlebar of claim 1 wherein the mounting piece has a slot running through a portion of the mounting piece such that a user can finish drilling out the slot to attach instrumentation to the mounting piece via the slot.

9. The bike handlebar of claim 1 wherein a standard stock fork tube plug nut is covered by the plurality of handlebars.

10. The bike handlebar of claim 1 wherein each grip tube is sized such that a grip can be mounted over the grip tube.

11. The bike handlebar of claim 1 wherein each handlebar tube is sized such that equipment such as a clutch lever or brake lever may be mounted to the handlebar tube.

12. The bike handlebar of claim 1 wherein the offset opening is sized and positioned such that electrical wire can be run through the handlebar tube and be connected to electrical components.

13. A method to manufacture a bike handlebar comprising the steps of:
receiving user parameters, the user parameters including a desired handlebar style, a desired handlebar horizontal angle, a desired handlebar vertical angle, and a bike type;
determining a mounting piece to match the bike type and the desired handlebar style;
determining a handlebar tube based upon at least one of the bike type and the desired handlebar style;
orienting the handlebar tube to the mounting piece at the desired handlebar vertical angle and the desired handlebar horizontal angle; and
integrally attaching the handlebar tube to the mounting piece.

14. The method of claim 13 further comprising the steps of:
connecting a bushing in the handlebar tube, the bushing having a central opening and an offset opening; and
connecting a grip tube to the bushing at the central opening.

15. The method of claim 14 wherein the step of connecting a bushing to the handlebar tube comprises the step of permanently attaching the bushing to the handlebar by at least one of welding, brazing, or bonding.

16. The method of claim 13 further comprising the step of forming a slot through a portion of the mounting piece.

17. The method of claim 13 further comprising the steps of:
determining a riser based upon the bike type;
attaching a plurality of risers to the handlebar tube; and
wherein the step of integrally attaching the handlebar tube to the mounting piece comprises the step of attaching the handlebar tube to the plurality of risers.

18. The method of claim 13 further comprising the step of connecting instrumentation to the mounting piece.

19. The method of claim 13 further comprising the step of bending the handlebar tube to form the desired handlebar style.

20. The method of claim 13 wherein the step of integrally attaching the handlebar tube to the mounting piece comprises the step of integrally attaching the handlebar tube to the mounting piece at the desired horizontal angle and the desired vertical angle.
